(19) United States
(12) Patent Application Publication
(10) Pub. No.: US 2003/0166496 A1
(43) Pub. Date: Sep. 4, 2003

(54) Amine oxides as perfume solubility agents

(76) Inventors: Robert Allen Godfroid, West Chester, OH (US); Gina Isoldi, Ixelles (BE); Allessandra Tamburini, Genova (IT)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/355,851

(22) Filed: Jan. 31, 2003

Related U.S. Application Data
(60) Provisional application No. 60/353,279, filed on Feb. 1, 2002.
(60) Provisional application No. 60/355,005, filed on Feb. 7, 2002.

(51) Int. Cl. C11D 9/44

(52) U.S. Cl. 510/503; 510/101

(57) ABSTRACT

The purpose of the present invention is to provide a premix composition comprising (a) a perfume and (b) an amine oxide, wherein the weight ratio of (a):(b) is between 20:1 and 1:1. The inventions further relates to treating compositions comprising either said premix composition or a perfume and an amine oxide in a ratio of 20:1 to 1:1. In said premix composition, the amine oxide serves as a solubility agent for the perfume. The present invention further provides a method of solubilising a perfume in an amine oxide. The present invention also provides a method of treating a surface with the treating composition of the present invention comprising the steps of applying the treating composition to a surface and wiping said surface. The present invention further provides a process for preparing a premix composition comprising the step of solubilising a perfume in an amine oxide, wherein the perfume to amine oxide ratio is between 20:1 to 1:1.

### CROSS REFERENCE TO RELATED APPLICATION

This application claims the benefit of U.S. Provisional Application No. 60/353279, filed on Feb. 1, 2002; and of U.S. Provisional Application No. 60/355005, filed on Feb. 7, 2002.

### FIELD OF THE INVENTION

This invention relates to a premix composition comprising a perfume and an amine oxide and to treating compositions comprising either said premix composition or a perfume and an amine oxide. The present treating compositions are advantageous for use on fabrics and hard surfaces including kitchen and bathroom surfaces, tiles, glass surfaces, countertops, walls, dishes, and ceramic, vinyl and finished wood floors. Such treating compositions can further comprise conventional ingredients.

### BACKGROUND OF THE INVENTION

Perfumed compositions are well-known in the art. Consumer acceptance of such perfumed compositions is determined not only by the performance achieved with these products but also by the aesthetics associated therewith. The perfume components are therefore an important aspect of the successful formulation of such commercial products.

Previously available compositions comprising perfumes are described in for example: U.S. Pat. No. 5,814,591 (Clorox) discloses an aqueous hard surface cleaner with improved soil removal properties comprising (a) a nonionic or an amphoteric surfactant; (b) not more than 50% wt. of at least one water-soluble or dispersible organic solvent; (c) from 0.01 to 25% wt. of tetraammonium ethylenediamine-tetraacetate; and (d) optionally from 0.0 to 0.3% of a perfume.

Additionally, the consumer has specific expectations from the perfume of said compositions. Firstly, having treated a surface with a perfumed composition, it is desirable to maintain the pleasing fragrance imparted by the treatment composition over a prolonged period. Indeed, perfumes not only make such compositions themselves more aesthetically pleasing by masking any unpleasant malodor of said compositions, but also impart a pleasant fragrance to surfaces treated therewith. However, the amount of perfume carried over from the composition or aqueous wash liquor containing said composition onto the surface is often marginal and thus does not last long on the surface or in the room. Industry, therefore, continues to look with urgency for more efficient and effective fragrance delivery methods, especially in the provision of long-lasting fragrance to treated surfaces.

Secondly, individual consumer preference for different perfumes and perfume types means that manufactures of those perfumed compositions must formulate a range of different perfumed product compositions of the same general type in order to appeal to the majority of consumers. However, this poses a problem since manufactures are limited by the perfume components that can be used to make the perfume. Generally, perfume components are relatively hydrophobic. It can therefore be difficult to solubilise said perfume components in an essentially aqueous composition. This problem is further exaserbated when perfume components at high molecular weight are used. In response to this problem, perfume and composition manufactures have introduced solubility agents to improve the solubility of the perfume components. See for example: U.S. Pat. No. 5,851,976 (Colgate-Palmolive) discloses an aqueous cleaning composition comprising (a) from 0.1 to 10% wt. of an anionic surfactant; (b) from 0.02 to 10% wt. of an amine oxide surfactant; (c) from 0.05 to 2% of a fatty acid; (d) from 0.4 to 10% wt. of a water-insoluble hydrocarbon, essential oil or perfume; and (e) from 0.5 to 15% wt. of a water-mixable co-surfactant, which serves as a solubility agent for the perfume.

However, the need to solubilise a perfume must be balanced with the need to minimize the concentration of non-volatile components in said compositions. Non-volatile components, e.g., surfactants and/or solubility agents, can leave visible residues in the form of streaks, films and hazes on treated surfaces.

EP 572 080 (Quest Int.) is concerned with the solubilisation of a perfume with limited amounts of anionic and nonionic surfactants and discloses a clear oil-in-water microemulsion comprising a perfume oil, one or more anionic and/or nonionic surfactants and less than 10% wt. of a lower aliphatic alcohol. However, the applicant of the present invention has found that the non-volatile components, e.g., the nonionic surfactant, of the microemulsion of EP 572 080 leave visible residues on surfaces treated therewith. Consequently, despite the advances in the art, there is still a need to solubilise a perfume without leaving unwanted, visible residues on treated surfaces.

It has been surprisingly found that the combination of a perfume and an amine oxide at relatively high level of perfume to relatively low level of amine oxide as solubility agent overcomes the solubility problems of a perfume. Treating compositions comprising a perfume and an amine oxide either as such or in the form of a premix composition results in a reduction in the amount of visible residues on treated surfaces.

The treating compositions of the present invention can be alkaline or acidic. An acidic composition is useful for removing hard water deposits. However, and preferably, the compositions of the present invention are alkaline. Such compositions further comprise an alkalinity agent. These alkalinity agents increase the perfume solubility to a greater extent than an equal mass of solubility agents. The preferred alkalinity source is volatile and does not contribute to visible residues on surfaces after treatment of those surfaces with the treating compositions of the present invention. The combination of a solubility agent and alkalinity source shows a synergetic effect on the solubility of a perfume in the compositions of the present invention. Preferable, said perfume gives a long-lasting odor profile to said room or surface.

### SUMMARY OF THE INVENTION

The purpose of the present invention is to provide a premix composition comprising (a) a perfume and (b) an amine oxide, wherein the weight ratio of (a):(b) is between about 20:1 and about 1:1. The inventions further relates to treating compositions comprising either said premix composition or a perfume and an amine oxide in a ratio of about 20:1 to about 1:1. In said premix composition, the amine oxide serves as a solubility agent for the perfume. The present invention further provides a method of solubilising a perfume in an amine oxide. The present invention also provides a method of treating a surface with the treating composition of the present invention comprising the steps of applying the treating composition to a surface and optionally wiping said surface. The present invention further provides a process for preparing a premix composition comprising the step of solubilising a perfume in an amine oxide, wherein the perfume to amine oxide ratio is between about 20:1 to about 1:1.

### DETAILED DESCRIPTION OF THE INVENTION

The present invention provides a premix composition comprising (a) a perfume and (b) an amine oxide, wherein the weight ratio of (a):(b) is between about 20:1 and about 1:1. The inventions further relates to treating compositions comprising either said premix composition or a perfume and an amine oxide in a ratio of about 20:1 to about 1:1. In said premix composition, the amine oxide serves as a solubility agent for the perfume. The present invention further provides a method of solubilising a perfume in an amine oxide. The present invention also provides a method of treating a surface with the treating composition of the present invention comprising the steps of applying the treating composition to a surface and wiping said surface. The present invention further provides a process for preparing a premix composition comprising the step of solubilising a perfume in an amine oxide, wherein the perfume to amine oxide ratio is between about 20:1 to about 1:1.

Perfume

Perfumes usually comprise a number of perfume components. Perfume components are defined herein as singular perfume molecules each having olfactory characteristics. A perfume comprises a number and usually a variety of different perfume components, the combination of which provides a distinctive olfactory characteristic that may be different to the olfactory character of the individual perfume components.

Perfume is one of the essentials components of the premix composition and of the treating composition of the present invention.

Preferred perfumes and perfume components are those that are relatively water-soluble and/or volatile to minimize spotting and filming. Such perfumes are described in more detail in U.S. Pat. No. 5,108,660, Michael, issued Apr. 28, 1992, at col. 8 lines 48 to 68, and col. 9 lines 1 to 68, and col. 10 lines 1 to 24, said patent, and especially said specific portion, being incorporated by reference.

Perfume components may be selected from natural products such as essential oils, absolutes, resinoids, resins, concretes, etc., and/or synthetic perfume components such as hydrocarbons, alcohols, aldehydes, ketones, ethers, acids, acetals, ketals, nitriles, and the like, including saturated and unsaturated compounds, aliphatic, carbocyclic and heterocyclic compounds.

Non limiting examples of such perfume components are: geraniol, geranyl acetate, linalool, linalyl acetate, tetrahydrolinalool, citronellol, citronellyl acetate, dihydromyrcenol, dihydromyrcenyl acetate, terpineol, terpinyl acetate, acetate, 2-phenylethanol, 2-phenylethyl acetate, benzyl alcohol, benzyl acetate, benzyl salicylate, benzyl benzoate, styrallyl acetate, amyl salicylate, dimenthylbenzylcarbinol, trichloromethylphenycarbinyl acetate, p-tert.butylcyclohexyl acetate, isononyl acetate, alpha-n-amylcinammic aldehyde, alpha-hexyl-cinammic aldehyde, 2-methyl-3-(p-tert.butylphenyl)-propanal, 2-methyl-3(p-isopropylphenyl)propanal, 3-(p-tert.butylphenyl)propanal, tricyclodecenyl acetate, tricyclodecenyl propionate, 4-(4-hydroxy-4-methylpentyl)-3-cyclohexenecarbaldehyde, 4-(4-methyl-3-pentenyl)-3cyclohexenecarbaldehyde, 4-acetoxy-3-pentyl-tetrahhydropyran, methyl dihydrojasmonate, 2-n-heptyl-cyclopentanone, 3-methyl-2-pentyl-cyclopentanone, n-decanal, n-dodecanal, 9-decenol-1, phenoxyethyl isobutyrate, phenylacetaldehyde dimenthyl acetal, phenylacetaldehyde dicetyll acetal, geranonitrile, citronellonitrile, cedryl acetate, 3-isocamphyl-cyclohexanol, cedryl ether, isolongifolanone, aubepine nitrile, aubepine, heliotropine, coumarin, eugenol, vanillin, diphenyl oxide, hydroxycitronellal, ionones, methyl ionones, isomethyl ionones, irones, cis-3-hexenol and esters thereof, indane musks, tetralin musks, isochroman musks, macrocyclic ketones, macrolactone musks, ethylene brassylate, and aromatic nitromusk.

In a preferred execution, the perfume components are relatively hydrophobic and relatively highly volatile (relatively low boiling point). This group of perfumes is defined as: having a boiling point of less than 260° C., preferably less than 240° C., more preferably less than 220° C. and a ClogP of at least 3, preferably more than 3.1, and even more preferably more than 3.2.

The logP of many components has been reported; for example, the Pomona92 database, available from Daylight Chemical Information Systems, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each component, and takes into account the numbers and types of atoms, the atom connectivity, and chemical bonding. The ClogP values are more reliable and more widely used than the experimental logP values.

Table 1
Examples of hydrophobic, volatile perfume materials

| | ClogP | Boiling Pt. | Boiling Pt. |
|---|---|---|---|
| Perfume Material | (calculated) | (measured) | (calculated) |
| Allo-ocimene | 4.36 | | 195 |
| Allyl cyclohexanepropionate | 3.94 | | 252 |
| Allyl heptanoate | 3.40 | | 209 |
| trans-Anethole | 3.31 | 232 | |
| Benzyl butyrate | 3.02 | 240 | |
| Camphene | 4.18 | 160 | |
| Cadinene | 7.27 | | 252 |
| Carvacrol | 3.40 | 238 | |
| cis-3-Hexenyl tiglate | 3.80 | | 225 |
| Citronellol | 3.25 | 223 | |
| Citronellyl acetate | 4.20 | 234 | |
| Citronellyl nitrile | 3.09 | 226 | |
| Citronellyl propionate | 4.73 | | 257 |
| Cyclohexylethyl acetate | 3.36 | 222 | |
| Decyl Aldehyde (Capraldehyde) | 4.01 | 208 | |
| Dihydromyrcenol | 3.03 | 192 | |
| Dihydromyrcenyl acetate | 3.98 | | 221 |
| 3,7-Dimethyl-1-octanol | 3.74 | 205 | |
| Diphenyloxide | 4.24 | 259 | |
| Fenchyl Acetate | 3.53 | | 234 |
| (1,3,3-Trimethyl-2-norbornanyl | | | |
| acetate) | | | |
| Geranyl acetate | 3.72 | 233 | |
| Geranyl formate | 3.27 | | 231 |
| Geranyl nitrile | 3.25 | 228 | |
| cis-3-Hexenyl isobutyrate | 3.27 | | 204 |
| Hexyl Neopentanoate | 4.06 | | 213 |
| Hexyl tiglate | 4.28 | | 221 |
| alpha-Ionone | 3.71 | 237 | |
| Isobornyl acetate | 3.53 | 238 | |
| Isobutyl benzoate | 3.57 | 242 | |
| Isononyl acetate | 4.28 | | 220 |
| Isononyl alcohol | 3.08 | 194 | |
| (3,5,5-Trimethyl-1-hexanol) | | | |
| Isopulegyl acetate | 3.70 | | 243 |
| Lauraldehyde | 5.07 | 250 | |
| d-Limonene | 4.35 | 177 | |
| Linalyl acetate | 3.50 | | 230 |
| (-)-L-Menthyl acetate | 4.18 | 227 | |
| Methyl Chavicol (Estragole) | 3.13 | 216 | |
| Methyl n-nonyl acetaldehyde | 4.85 | 247 | |
| Methyl octyl acetaldehyde | 4.32 | | 224 |
| beta-Myrcene | 4.33 | | 165 |
| Neryl acetate | 3.72 | 236 | |
| Nonyl acetate | 4.41 | 229 | |
| Nonaldehyde | 3.48 | 191 | |
| p-Cymene | 4.07 | 173 | |
| alpha-Pinene | 4.18 | 156 | |
| beta-Pinene | 4.18 | 166 | |
| alpha-Terpinene | 4.41 | 175 | |
| gamma-Terpinene | 4.35 | 183 | |
| alpha-Terpinyl acetate | 3.58 | 220 | |
| Tetrahydrolinalool | 3.52 | 202 | |
| Tetrahydromyrcenol | 3.52 | 195 | |
| 2-Undecenal | 4.22 | | 235 |
| Verdox (o-t-Butylcyclohexyl | 4.06 | | 239 |
| acetate) | | | |
| Vertenex (4-tert.Butylcyclohexyl | 4.06 | | 237 |
| acetate) | | | |

In another preferred execution, the perfume components are relatively hydrophobic and have relatively low volatility (relatively high boiling point). This group of perfumes is defined as: having a boiling point of greater than 260° C., preferably greater than 275° C., and more preferably greater than 290° C., and a ClogP of at least 3, preferably more than 3.1, and even more preferably more than 3.2.

Table 2
Examples of hydrophobic, but less volatile perfume materials

| | ClogP | Boiling Pt. | Boiling Pt. |
|---|---|---|---|
| Perfume Material | (calculated) | (measured) | (calculated) |
| (Ambrettolide) | 6.36 | | 352 |
| Oxacycloheptadec- | | | |
| 10-en-2-one | | | |
| (Amyl benzoate) n-Pentyl | 4.23 | | 263 |
| benzoate | | | |
| Isoamyl cinnamate | 4.45 | | 300 |
| alpha-Amylcinnamaldehyde | 4.32 | 289 | |
| alpha-Amylcinnamaldehyde | 4.03 | | 320 |
| dimethyl acetal | | | |
| (iso-Amyl Salicylate) | 4.43 | 277 | |
| isopentyl salicylate | | | |
| (Aurantiol) Methyl | 4.22 | | 413 |
| anthranilate/hydroxy- | | | |
| citronellal Schiff base | | | |
| Benzophenone | 3.18 | 305 | |
| Benzyl salicylate | 4.21 | 320 | |
| beta-Caryophyllene | 6.45 | | 263 |
| Cedrol | 4.53 | | 274 |
| Cedryl acetate | 5.48 | | 289 |
| Cinnamyl cinnamate | 4.64 | | 387 |
| Citronellyl isobutyrate | 5.04 | | 266 |
| Cyclohexyl salicylate | 4.48 | | 327 |
| Cyclamen aldehyde | 3.46 | | 271 |
| delta-Dodecalactone | 4.39 | | 279 |
| (Dihydro Isojasmonate) | 3.09 | | 314 |
| Methyl 2-hexyl-3-oxo- | | | |
| cyclopentanecarboxylate | | | |
| Diphenylmethane | 4.06 | 265 | |
| Ethylene brassylate | 4.62 | | 390 |
| Ethyl undecylenate | 4.99 | 261 | |
| Iso E Super | 4.85 | | 307 |
| (Exaltolide) Pentadecanolide | 6.29 | | 338 |
| (Galaxolide) 4,6,6,7,8,8- | 6.06 | | 335 |
| Hexamethyl-1,3,4,6,7,8- | | | |
| hexahydro-cyclopenta(G)-2- | | | |
| benzopyran | | | |
| gamma-Methyl Ionone (alpha- | 4.02 | | 278 |
| Isomethylionone) | | | |
| Geranyl isobutyrate | 5.00 | | 295 |
| Hexadecanolide | 6.85 | | 352 |
| cis-3-Hexenyl salicylate | 4.61 | | 323 |
| alpha-Hexylcinnamaldehyde | 4.85 | | 334 |
| n-Hexyl salicylate | 5.09 | | 318 |
| alpha-Irone | 4.23 | | 279 |
| 6-Isobutylquinoline | 3.99 | | 294 |
| Lilial (p-tert.Butyl-alpha- | 3.86 | | 282 |
| methyldihydro-cinnamic | | | |
| aldehyde, PT Bucinol) | | | |
| Linalyl benzoate | 5.42 | | 325 |
| (2-Methoxy Naphthalene) | 3.24 | 274 | |
| beta-Naphthyl methyl ether | | | |
| 10-Oxahexadecanolide | 4.38 | | 355 |
| Patchouli alcohol | 4.53 | | 317 |
| (Phantolide) 5-Acetyl- | 5.69 | | 333 |
| 1,1,2,3,3,6- | | | |
| hexa-methylindan | | | |
| Phenethyl benzoate | 4.06 | | 335 |
| Phenethyl phenylacetate | 3.77 | | 350 |
| Phenyl Hexanol (3-Methyl-5- | 3.17 | | 296 |
| phenyl-1-pentanol) | | | |
| Tonalid (7-Acetyl-1,1,3,4,4,6- | 6.25 | | 344 |
| hexamethyl-tetralin) | | | |
| delta-Undecalactone | 3.86 | | 262 |
| gamma-Undecalactone | 3.83 | 286 | |
| Vertinert Acetate | 5.47 | | 332 |

Amine Oxide

Suitable amine oxides according to the present invention are those having the formula:

R₁R₂R₃NO

wherein each of R₁, R₂ and R₃ is independently a saturated or unsaturated, substituted or unsubstituted, linear or branched hydrocarbon chains of from 1 to 30 carbon atoms. Preferred amine oxides to be used according to the present invention are amine oxides having the following formula: R₁R₂R₃NO wherein R₁ is an hydrocarbon chain comprising from 1 to 30 carbon atoms, preferably from 6 to 20, more preferably from 8 to 18, most preferably from 12 to 14; and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups or 2-hydroxyethyl groups. R₁ may be a saturated or unsaturated, substituted or unsubstituted linear or branched hydrocarbon chain.

By substituted it is meant, substituted by any suitable substituent, such as chloride, bromide, iodide, and hydroxy, preferably hydroxy.

Exemplary of the preferred amine oxides are the N-hexyldimethylamine oxide, N-octyldimethylamine oxide, N-decyldimethylamine oxide, N-dodecyl dimethylamine oxide, N-tetradecyldimethylamine oxide, N-hexadecyl dimethylamine oxide, N-octadecyldimethylamine oxide, N-eicosyldimethylamine oxide, and the corresponding amine oxides in which one or both of the methyl groups are replaced with ethyl or 2-hydroxyethyl groups and mixtures thereof. The most preferred amine oxides for use herein are N-dodecyldimethylamine oxide and N-tetradecyldimethylmethylamine oxide or a mixture thereof.

Suitable amine oxides for use herein are for instance natural blend C₈-C₁₀ amine oxides as well as C₁₂-C₁₆ amine oxides commercially available from Hoechst, preferred amine oxide is C₁₂-C₁₄ dimethyl amine oxide commercially available from Albright & Wilson, C₁₂-C₁₄ amine oxides commercially available under the trade name Genaminox® LA from Hoechst or AROMOX® DMMCD-W from AKZO or C14 amine oxides commercially available under the trade name AROMOX® DM14D-W970 (-AO) from AKZO.

Another group of amine oxides suitable for the present invention are those having the formula:

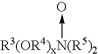

wherein R³ is an alkyl, hydroxyalkyl, or alkyl phenyl group or mixtures thereof containing from 8 to 22 carbon atoms; R⁴ is an alkylene or hydroxyalkylene group containing from 2 to 3 carbon atoms or mixtures thereof; x is from 0 to 3; and each R⁵ is an alkyl or hydroxyalkyl group containing from 1 to 3 carbon atoms or a polyethylene oxide group containing from 1 to 3 ethylene oxide groups. The R⁵ groups can be attached to each other, e.g., through an oxygen or nitrogen atom, to form a ring structure.

These amine oxides in particular include C₁₀-C₁₈ alkyl dimethyl amine oxides and C₈-C₁₂ alkoxy ethyl dihydroxy ethyl amine oxides, more preferably the C₁₂-C₁₄ alkyl dimethyl amine oxide.

Premix Composition

The premix composition of the present invention is used to solubilise the perfume before adding it to a treating composition. In the premix composition, the perfume is present from about 5% to about 96% by weight of the premix composition, preferably from about 50% to about 95% wt. of the premix composition. In the case of the preferred embodiment containing peroxide, the perfumes must be chosen so as to be compatible with the oxidant. The premix composition comprises the amine oxide at a level of from about 4 to about 95% by weight of the premix composition, preferably from about 30% to about 50% by weight of the premix composition.

The weight ratio of the perfume to the amine oxide is between about 20:1 and about 1:1, preferably between about 10:1 and about 1:1, more preferably between about 6:1 and about 1:1 and most preferably between about 5:1 and about 1:1.

Furthermore, an alcohol may optionally be present. Said alcohol is selected from the group consisting of C₁-C₂₀ linear, branched, cyclic, saturated, unsaturated, unsubstituted and substituted alcohols and mixtures thereof. Preferably, said alcohol is selected from the group consisting of water-soluble C₁-C₆ linear, branched, cyclic, saturated, unsaturated, unsubstituted and substituted alcohols and mixtures thereof. More preferably, said alcohol is selected from the group consisting of ethanol, propanol, iso-propanol, butanol, iso-butanol, sec.-butanol and tert.-butanol and mixtures thereof. Most preferably, said alcohol is selected from the group consisting of ethanol, propanol, and iso-propanol and mixtures thereof. The premix composition encompasses said alcohol, when present, at a level of from about 0.0%, preferably from about 0.01%, more preferably from about 0.1%, to about 20%, preferably to about 10%, more preferably to about 6% by weight of the premix composition.

Treating Composition

The treating composition of the present invention comprises the premix composition or a perfume and an amine oxide, where the perfume is solubilised in situ.

Treating compositions comprising either said premix composition or a perfume and an amine oxide, where the perfume is solubilised in situ, typically comprise perfume at a level of from about 0.005% to about 2%, preferably between about 0.01% to about 1%, more preferably between about 0.01% to about 0.2% and most preferably between about 0.01% to about 0.08% by weight of the treating composition.

Treating compositions comprising either said premix composition or a perfume and an amine oxide, where the perfume is solubilised in situ, typically comprise the amine oxide at a level from about 0.005% to about 1%, preferably from about 0.005% to about 0.5%, more preferably from about 0.005% to about 0.1% and most preferably from about 0.005% to about 0.06% by weight of the treating composition.

The weight ratio of the perfume to the amine oxide is between about 20:1 and about 1:1, preferably between about 10:1 and about 1:1, more preferably between about 6:1 and about 1:1 and most preferably between about 5:1 and about 1:1.

Preferred optional ingredient of the treating composition of the present invention is a soil entrainment system. The soil entrainment system comprises of one or more modified polyamine compounds, polyethylene glycols with a specific molecular weight range, one or more modified polyacrylamide compounds and mixtures thereof.

In a preferred embodiment, a polymeric material that improves the hydrophilicity of the surface being treated is added into the treating composition of the present invention. The increase in hydrophilicity provides improved final appearance by providing “sheeting” of the water from the surface and/or spreading of the water on the surface, and this effect is preferably seen when the surface is rewetted and even when subsequently dried after the rewetting.

“Sheeting” effects have been noted on a variety of surfaces such as glass, ceramic and even tougher to wet surfaces such as porcelain enamel. When the water “sheets” evenly off the surface and/or spreads on the surface, it minimizes the formation of, e.g., “hard water spots” that form upon drying. For a product intended to be used in the context of a floor cleaner, the polymer improves surface wetting and assists cleaning performance.

Polymer substantivity is beneficial as it prolongs the sheeting and cleaning benefits. Another important feature of preferred polymers is lack of residue upon drying. Compositions comprising preferred polymers dry more evenly on floors while promoting an end result with little or no haze.

Many materials can provide the sheeting and anti-spotting benefits, but the preferred materials are polymers that contain amine oxide hydrophilic groups.

The treating compositions of the present invention may further comprise a surfactant, or mixtures thereof as a highly preferred optional ingredient.

Said surfactant may be present in the treating compositions according to the present invention in amounts of from about 0.01% to about 50%, preferably of from about 0.1% to about 20%, and more preferably of from about 0.5% to about 1% by weight of the treating composition.

Surfactants are desired herein as they further contribute to the cleaning performance benefit of the treating compositions of the present invention and/or provide a gloss benefit to the treating composition of the present invention. Furthermore, the combination of the alkanol with a surfactant when present results in an improved wetting, providing a further improved streak-free treating and/or treating performance benefit.

Surfactants for use herein include all nonionic surfactants, anionic surfactants, cationic surfactants, amphoteric surfactants, zwitterionic surfactants, and mixtures thereof known in the art and suitable for the applications herein.

In a preferred embodiment, said surfactant is selected from the group consisting of nonionic surfactants, anionic surfactants and mixtures thereof. Preferably, said surfactant is selected from the group consisting of: polyethylene oxide condensates of alkyl phenols; condensation products of primary and secondary aliphatic alcohols with from 1 to 25 moles of ethylene oxide; alkylpolysaccharides; alkyl sulfates; alkyl benzene sulphonates; and mixtures thereof. More preferably, said surfactant is selected from the group consisting of: condensation products of primary and secondary aliphatic alcohols with from 1 to 25 moles of ethylene oxide; alkyl benzene sulphonates; and mixtures thereof

As an optional but highly preferred ingredient the treating composition herein comprises one or more solvents or mixtures thereof. Solvents can provide improved filming and/or streaking benefits. Whilst not wishing to be limited by theory, it is believed that solvents disrupt micelle formation, thus reducing surfactant aggregation. As such, they act as gloss toning agents, reducing gloss loss or promoting gloss gain on the surfaces of the present invention. Solvents are also beneficial because of their surface tension reduction properties help the cleaning profile of the treating compositions disclosed herein. Finally, solvents, particularly solvents with high vapour pressure, specifically vapour pressures of 0.05 mm Hg at 25° C. and 1 atmosphere pressure (6.66 Pa) or higher, can provide cleaning and filming and/or streaking benefits without leaving residue.

Solvents for use herein include all those known in the art for use in hard-surface cleaner treating compositions. Suitable solvents can be selected from the group consisting of: ethers and diethers having from 4 to 14 carbon atoms, preferably from 6 to 12 carbon atoms, and more preferably from 8 to 10 carbon atoms; glycols or alkoxylated glycols; glycol ethers; alkoxylated aromatic alcohols; aromatic alcohols; and mixtures thereof. Glycol ether solvents are most preferred, particularly those with vapour pressure of 0.05 mm Hg at 25° C. and 1 atmosphere pressure (6.66 Pa).

When present, solvents are found to be most effective at levels from about 0.5% to about 25%, more preferably from about 1.0% to about 20% and most preferably from about 2% to about 15% by weight of the treating composition.

Other preferred but optional adjuncts in the present treating composition include alkalinity agents and buffers, especially amines, more especially 2-(N,N-dimethylamino)-2-methyl-1-propanol and 1,3-bis(methylamine)-cyclohexane. When used, these alkalinity agents and buffers are present from about 0.0001% to about 1.0%, preferably between about 0.0005% to about 0.1%, more preferably between about 0.005% to about 0.1% and most preferably between about 0.005% to about 0.06% by weight of the treating composition, with the higher levels being more preferred for the more volatile alkalinity agents and buffer materials.

Other preferred but optional adjuncts include preservatives, antimicrobial agents, suds suppressors, builders, thickening agents, peroxide, peroxide stabilising system, acidifying agents and mixtures thereof.

The treating composition of the present invention is preferably aqueous, comprising water at a level of at least about 80%, more preferably of from about 80% to about 99.5% and most preferably of from about 85% to about 95% by weight of the treating composition. The aqueous treating composition is typically in micellar form, and does not incorporate substantial levels of water insoluble components that induce significant micellar swelling. The aqueous solvent system can also comprise, in addition to water, low molecular weight, highly water-soluble solvents typically found in detergent compositions, e.g., ethanol, isopropanol, etc. These solvents can be used to provide disinfectancy properties to treating compositions that are otherwise low in active. Additionally, they can be particularly useful in treating compositions wherein the total level of perfume is very low. In effect, highly volatile solvents can provide “lift”, and enhance the character of the perfume. Highly volatile solvents, if present are typically present in from about 0.25% to about 5%, more preferably from about 0.5% to about 3%, most preferably from about 0.5% to about 2%, by weight of the treating composition. Examples of such solvents include methanol, ethanol, isopropanol, n-butanol, iso-butanol, 2-butanol, pentanol, 2-methyl-1-butanol, methoxymethanol, methoxyethanol, methoxy propanol, propoxy propanol and mixtures

The compositions of the present invention therefore preferably additionally comprise an alcohol. More preferably, the alcohol is selected from the group consisting of C₁-C₂₀ linear, branched, cyclic, saturated, unsaturated, unsubstituted and substituted alcohols and mixtures thereof.

In one embodiment of the present invention, the treating compositions are applied on hard surfaces soiled with hard watermarks, limescale and/or soap scum. Such soils are frequently encountered on kitchen and bathroom surfaces. Accordingly, the treating compositions herein may further comprise acid or base buffers to adjust pH as appropriate.

Process of Preparing the Premix Composition

The premix composition of the present invention can be made by mixing together all ingredients in any order. It has been found that for maximum perfume solubilisation it is advantageous to add the perfume to the amine oxide at such a temperature that a homogenous mixture is obtained and to stir that mixture for at least two minutes, followed by the addition of the optional ingredients. This process can be carried out with standard laboratory equipment, e.g., in a beaker with a magnetic stirring bar and a magnetic stirrer. The temperature should not be higher than necessary to obtain a homogenous premix composition comprising a perfume and an amine oxide in order to prevent loss or deterioration of perfume.

Process of Preparing the Treating Composition, Comprising the Premix Composition or Comprising a Perfume and an Amine Oxide

The treating compositions of the present invention impart good cleaning benefits to any surface and impart beneficial odor profile to rooms and surfaces such as kitchen and bathroom surfaces, tiles, glass surfaces, countertops, walls, dishes, fabrics and ceramic, vinyl and finished wood floors, which have been contacted with such treating compositions.

Liquid treating compositions are usually preferred, since they have the advantage that they can be applied to hard surfaces in neat or concentrated form so that a relatively high level of, e.g., surfactant material and/or organic solvent is delivered directly to the soil. However, solid treating compositions can also be used to form a cleaning solution when diluted with water. Concentrated liquid treating compositions can also help improve the value equation for consumers by economizing on packaging costs, where the concentrated products are intended to be used in more dilute form. A concentrated, e.g., 10X refill, can also provide additional convenience to the consumer in that it lasts longer, weighs less, and occupies less space than a 1X product. Liquid treating compositions in the form of a “wipe” also can provide convenience by allowing the consumer to use the wipe once and dispose of it.

The treating composition of the present invention can be made by mixing together all ingredients in any order. It has been found that for maximum perfume solubilisation it is advantageous to add the premix composition into water and to stir that mixture for at least two minutes, before the other ingredients are added. After this step the mixture is stirred with a higher sharing mixer, i.e. at 500 rpm for 30 minutes. This process can be carried out with standard laboratory equipment, e.g., in a beaker with a magnetic stirring bar and a magnetic stirrer.

For the preparation of a treating composition comprising a perfume and an amine oxide, where the perfume is solubilised insitu, all ingredients in can be mixed together in any order. It has been found that for maximum perfume solubilisation it is advantageous to add the perfume into a composition comprising water and the amine oxide and to stir that mixture for at least two minutes. Before the other ingredients are added. After this step the mixture is stirred with a higher sharing mixer, i.e. at 500 rpm for 30 minutes. This process can be carried out with standard laboratory equipment, e.g., in a beaker with a magnetic stirring bar and a magnetic stirrer.

Method of Solubilising a Perfume

A method of solubilising a perfume is provided. Said method encompasses the step of solubilising said perfume in an amine oxide, wherein the perfume to amine oxide ratio is between about 20:1 to about 1:1.

Method of Treating Surfaces

The present invention encompasses a process of treating a surface, preferably a hard surface, comprising the step of contacting, preferably wiping, said surface using the aqueous treating composition of the present invention. In a preferred embodiment of the present application, said process comprises the steps of contacting parts of said surface, more preferably soiled parts of said surface, with said aqueous treating composition. In a preferred embodiment soiled cleaning solution can be absorbed from the surface using a disposible wipe, optionally containing a superabsorbent gel. By “hard-surfaces”, it is meant herein any kind of surfaces typically found in houses like kitchens, bathrooms, or in car interiors or exteriors, e.g., ceramic, vinyl, and finished wood floors, walls, tiles, windows, sinks, showers, shower plastified curtains, wash basins, WCs, dishes, fixtures and fittings and the like made of different materials like ceramic, vinyl, no-wax vinyl, linoleum, melamine, glass, any plastics, plastified wood, metal or any painted or varnished or sealed surface and the like. Hard-surfaces also include household appliances including, but not limited to, refrigerators, freezers, washing machines, automatic dryers, ovens, microwave ovens, dishwashers and so on.

### EXAMPLES

1.) Examples of treating compositions for hard surface treating compositions including kitchen and bathroom surfaces, tiles, countertops, walls, dishes, fabrics and ceramic, vinyl and finished wood floors.

| Ingredients | A | B | C | D | E | F | G | H |
|---|---|---|---|---|---|---|---|---|
| C₁₂-C₁₄ amine oxide | 0.3 | 0.66 | 0.02 | 0.005 | 2.0 | 0.05 | 0.15 | 3.0 |
| Propoxypropanol | 3.0 | 1.0 | 2.0 | 5.0 | 0.1 | 6.0 | 0 | 10.0 |
| Isopropanol | 0 | 0 | 2.0 | 5.0 | 0 | 0 | 0.01 | 10.0 |
| Perfume | 0.4 | 0.66 | 0.04 | 0.1 | 2.5 | 0.75 | 0.3 | 3.0 |
| 2-(N,N-dimethyl- | 0.05 | 0.1 | 0.01 | 0.001 | 0.5 | 0.002 | 0.005 | 1.0 |
| amino)-2-methyl- | | | | | | | | |
| propanol | | | | | | | | |
| Poly(4-vinylpyridine | 0.05 | 0.005 | 0.02 | 0.06 | 0.03 | 0.08 | 0.01 | 0.1 |
| N-oxide), 25 M Da | | | | | | | | |
| Dow Corning | 0.05 | 0.005 | 0.02 | 0 | 0.03 | 0.06 | 0.01 | 0.1 |
| silicone suds | | | | | | | | |
| suppressor | | | | | | | | |
| Water | Bal. | Bal. | Bal. | Bal. | Bal. | Bal. | Bal. | Bal. |

2. Examples of treating compositions for hard surface treating compositions including glass surfaces.

| Ingredients | A | B | C | D | E | F | G | H |
|---|---|---|---|---|---|---|---|---|
| C₁₂-C₁₄ amine oxide | 0.3 | 0.66 | 0.02 | 0.005 | 2.0 | 0.05 | 0.15 | 3.0 |
| Propoxypropanol | 3.0 | 1.0 | 2.0 | 5.0 | 0.1 | 6.0 | 0 | 10.0 |
| Isopropanol | 0 | 0 | 2.0 | 5.0 | 0 | 0 | 0.01 | 10.0 |
| Perfume | 0.4 | 0.66 | 0.04 | 0.1 | 2.5 | 0.75 | 0.3 | 3.0 |
| 2-(N,N-dimethyl- | 0.05 | 0.1 | 0.01 | 0.001 | 0.5 | 0.002 | 0.005 | 1.0 |
| amino)-2-methyl- | | | | | | | | |
| propanol | | | | | | | | |
| Poly(4-vinylpyridine | 0.05 | 0.005 | 0.02 | 0.06 | 0.03 | 0.08 | 0.01 | 0.1 |
| N-oxide), 25 M Da | | | | | | | | |
| Dow Corning | 0.05 | 0.005 | 0.02 | 0 | 0.03 | 0.06 | 0.01 | 0.1 |
| silicone suds | | | | | | | | |
| suppressor | | | | | | | | |
| Alkyl Sulfate | 0.1 | 0.02 | 0.007 | 0.01 | 0.03 | 0.2 | 0.015 | 0.08 |
| Water | Bal. | Bal. | Bal. | Bal. | Bal. | Bal. | Bal. | Bal. |

What is claimed is:

1. A premix composition comprising:
(a) a perfume, and
(b) an amine oxide, and,
wherein the weight ratio of (a):(b) is between about 20:1 and about 1:1.

2. A treating composition comprising one of the following:
(i) the premix composition of claim 1;
(ii) (a) a perfume, and
(b) an amine oxide, wherein the weight ratio of (a):(b) is between about 20:1 and about 1:1.

3. The composition according to claim 1 wherein the perfume has a boiling point of less than 260° C., and a ClogP of at least 3.

4. The composition according to claim 2 wherein the perfume has a boiling point of less than 260° C., and a ClogP of at least 3.

5. The composition according to claim 1 wherein the perfume has a boiling point of greater than 260° C., and a ClogP of at least 3.

6. The composition according to claim 2 wherein the perfume has a boiling point of greater than 260° C., and a ClogP of at least 3.

7. The composition according to claim 1 wherein the perfume is selected from the group consisting of geraniol, geranyl acetate, linalool, linalyl acetate, tetrahydrolinalool, citronellol, citronellyl acetate, dihydromyrcenol, dihydromyrcenyl acetate, terpineol, terpinyl acetate, acetate, 2-phenylethanol, 2-phenylethyl acetate, benzyl alcohol, benzyl acetate, benzyl salicylate, benzyl benzoate, styrallyl acetate, amyl salicylate, dimenthylbenzylcarbinol, trichloromethylphenycarbinyl acetate, p-tert.butyl-cyclohexyl acetate, isononyl acetate, alpha-n-amylcinammic aldehyde, alpha-hexyl-cinammic aldehyde, 2-methyl-3-(p-tert.butylphenyl)-propanal, 2-methyl-3(p-isopropylphenyl)propanal, 3-(p-tert.butylphenyl)propanal, tricyclodecenyl acetate, tricyclodecenyl propionate, 4-(4-hydroxy-4-methylpentyl)-3-cyclohexenecarbaldehyde, 4-(4-methyl-3-pentenyl)-3-cyclohexenecarbaldehyde, 4-acetoxy-3-pentyl-tetrahhydropyran, methyl dihydrojasmonate, 2-n-heptyl-cyclopentanone, 3-methyl-2-pentyl-cyclopentanone, n-decanal, n-dodecanal, 9-decenol-1, phenoxyethyl isobutyrate, phenylacetaldehyde dimenthyl acetal, phenylacetaldehyde dicetyll acetal, geranonitrile, citronellonitrile, cedryl acetate, 3-isocamphyl-cyclohexanol, cedryl ether, isolongifolanone, aubepine nitrile, aubepine, heliotropine, coumarin, eugenol, vanillin, diphenyl oxide, hydroxycitronellal, ionones, methyl ionones, isomethyl ionones, irones, cis-3-hexenol and esters thereof, indane musks, tetralin musks, isochroman musks, macrocyclic ketones, macrolactone musks, ethylene brassylate, and aromatic nitromusk and mixtures thereof.

8. The composition according to claim 2 wherein the perfume is selected from the group consisting of geraniol, geranyl acetate, linalool, linalyl acetate, tetrahydrolinalool, citronellol, citronellyl acetate, dihydromyrcenol, dihydromyrcenyl acetate, terpineol, terpinyl acetate, acetate, 2-phenylethanol, 2-phenylethyl acetate, benzyl alcohol, benzyl acetate, benzyl salicylate, benzyl benzoate, styrallyl acetate, amyl salicylate, dimenthylbenzylcarbinol, trichloromethylphenycarbinyl acetate, p-tert.butyl-cyclohexyl acetate, isononyl acetate, alpha-n-amylcinammic aldehyde, alpha-hexyl-cinammic aldehyde, 2-methyl-3-(p-tert.butylphenyl)-propanal, 2-methyl-3(p-isopropylphenyl)propanal, 3-(p-tert.butylphenyl)propanal, tricyclodecenyl acetate, tricyclodecenyl propionate, 4-(4-hydroxy-4-methylpentyl)-3-cyclohexenecarbaldehyde, 4-(4-methyl-3-pentenyl)-3-cyclohexenecarbaldehyde, 4-acetoxy-3-pentyl-tetrahhydropyran, methyl dihydrojasmonate, 2-n-heptyl-cyclopentanone, 3-methyl-2-pentyl-cyclopentanone, n-decanal, n-dodecanal, 9-decenol-1, phenoxyethyl isobutyrate, phenylacetaldehyde dimenthyl acetal, phenylacetaldehyde dicetyll acetal, geranonitrile, citronellonitrile, cedryl acetate, 3-isocamphyl-cyclohexanol, cedryl ether, isolongifolanone, aubepine nitrile, aubepine, heliotropine, coumarin, eugenol, vanillin, diphenyl oxide, hydroxycitronellal, ionones, methyl ionones, isomethyl ionones, irones, cis-3-hexenol and esters thereof, indane musks, tetralin musks, isochroman musks, macrocyclic ketones, macrolactone musks, ethylene brassylate, and aromatic nitromusk and mixtures thereof.

9. The composition according to claim 1 wherein the amine oxide has the formula:
R₁R₂R₃NO
wherein each of R₁, R₂ and R₃ is independently a saturated or unsaturated, substituted or unsubstituted, linear or branched hydrocarbon chain of from 1 to 30.

10. The composition according to claim 2 wherein the amine oxide has the formula:
R₁R₂R₃NO
wherein each of R₁, R₂ and R₃ is independently a saturated or unsaturated, substituted or unsubstituted, linear or branched hydrocarbon chain of from 1 to 30.

11. The composition according to claim 1 wherein the amine oxide is selected from the group consisting of N-hexyldimethylamine oxide, N-octyldimethylamine oxide, N-decyldimethylamine oxide, N-dodecyl dimethylamine oxide, N-tetradecyldimethylamine oxide, N-hexadecyl dimethylamine oxide, N-octadecyldimethylamine oxide, N-eicosyldimethylamine oxide, and the corresponding amine oxides in which one or both of the methyl groups are replaced with ethyl or 2-hydroxyethyl groups and mixtures thereof.

12. The composition according to claim 2 wherein the amine oxide is selected from the group consisting of N-hexyldimethylamine oxide, N-octyldimethylamine oxide, N-decyldimethylamine oxide, N-dodecyl dimethylamine oxide, N-tetradecyldimethylamine oxide, N-hexadecyl dimethylamine oxide, N-octadecyldimethylamine oxide, N-eicosyldimethylamine oxide, and the corresponding amine oxides in which one or both of the methyl groups are replaced with ethyl or 2-hydroxyethyl groups and mixtures thereof.

13. The composition according to claim 1 wherein the composition further comprises an alcohol.

14. The composition according to claim 2 wherein the composition further comprises an alcohol.

15. The composition according to claim 1 further comprising an alkalinity agent.

16. The composition according to claim 2 further comprising an alkalinity agent.

17. The composition according to claim 15 wherein the alkalinity agent is an amine.

18. The composition according to claim 16 wherein the alkalinity agent is an amine.

19. The composition according to claim 2 wherein the level of perfume is between about 0.005% to about 2.0% by weight of the treating composition.

20. The composition according to claim 2 wherein the level of amine oxide is between about 0.005% to about 1.0% by weight of the treating composition.

21. The composition according to claim 2 wherein the composition is aqueous, comprising water at a level of at least about 80% by weight of the treating composition.

22. Method of treating a surface with the treating composition according to claim 2 wherein said surface can be a fabric or a hard surface, comprising the steps of applying the treating composition to the surface.

23. A process for preparing a composition according to claim 1, comprising the steps of adding the perfume to the amine oxide in a weight ratio of perfume: amine oxide between about 20:1 and about 1:1.
